(19) United States
(12) Patent Application Publication
(10) Pub. No.: US 2021/0129901 A1
(43) Pub. Date: May 6, 2021

(54) VEHICLE HAVING POWER STEERING SYSTEM

(71) Applicant: Mahindra N.A. Tech Center, Auburn Hills, MI (US)

(72) Inventor: Matthew T. BROWN, South Lyon, MI (US)

(21) Appl. No.: 17/083,379

(22) Filed: Oct. 29, 2020

Related U.S. Application Data
(60) Provisional application No. 62/929,352, filed on Nov. 1, 2019.

(51) Int. Cl. B62D 5/04; B62D 5/24; B62D 15/02; B62D 7/06; B62D 7/18; B62D 7/20

(52) U.S. Cl. CPC B62D 5/046; B62D 5/0409; B62D 5/0421; B62D 5/0454; F16H 25/2204; B62D 15/0215; B62D 7/06; B62D 7/18; B62D 7/20; B62D 5/24

(57) ABSTRACT

A power steering system includes a steering shaft, a linkage assembly, a first power assist assembly, and a second power assist assembly. The linkage assembly includes an input member drivingly connected to the steering shaft and an output member adapted to be drivingly connected to steerable wheels. The first power assist assembly is drivingly connected to the steering shaft and is arranged to apply a torque to the steering shaft to supplement a driver input force and change the direction of the steerable wheels. The second power assist assembly includes an electric motor drivingly connected to one of the steering shaft and the linkage assembly. The electric motor is arranged to apply torque to the steering shaft or the linkage assembly to change the direction of the steerable wheels with or without a presence of the driver input force to the steering shaft.

### CROSS-REFERENCE TO RELATED APPLICATIONS

This application claims the benefit of U.S. Provisional Application No. 62/929,352, filed on Nov. 1, 2019. The entire disclosure of the above application is incorporated herein by reference.

### FIELD

The present disclosure relates to a vehicle having a power steering system.

### BACKGROUND

This section provides background information related to the present disclosure and is not necessarily prior art.

Some vehicles include a solid axle suspension system which include, inter alia, a solid axle, shock absorbers, leaf springs, and coil springs. The solid axle attaches a front set of wheels such that when one of the wheels articulates (moves up or down) the other wheel moves in the same or opposite direction. The shock absorbers dampen movement of the wheels with respect to the frame. The coil springs and the leaf springs support the load of the vehicle and absorb road impact transmitted through the wheels. The solid axle suspension system is beneficial as it can carry heavy loads while requiring very little to no maintenance.

Vehicles that include a solid axle suspension system are either not power assisted or have a hydraulic power steering system that uses hydraulic fluid to apply a torque to a vehicle steering shaft to supplement a driver input force. Electric power assist is not easily added to such vehicles due to the design of the solid axle suspension system.

Thus, the present disclosure provides an electric power steering system that is able to be retro-fitted onto vehicles having a solid axle suspension system. In this way, the vehicle may be made autonomous such that it can steer itself without the need of a driver input force to the steering assembly and a variety of driver aids can be added to the system such as lane keeping or vibrating the steering wheel to get the driver's attention. Furthermore, the electric power steering system is able to operate with or without the need of the hydraulic power steering system. Finally, the steering system can be tuned in ways not easy or possible with hydraulic power steering system.

### SUMMARY

This section provides a general summary of the disclosure, and is not a comprehensive disclosure of its full scope or all of its features.

In one form, the present disclosure provides a power steering system for a vehicle including steerable wheels. The power steering system includes a rotatable shaft, a linkage assembly, a first power assist assembly, and a second power assist assembly. The linkage assembly includes an input member drivingly connected to the steering shaft and an output member adapted to be drivingly connected to the steerable wheels. An input force to the steering shaft by a driver is transferred through the linkage to change a direction of the steerable wheels. The first power assist assembly is drivingly connected to the steering shaft and is arranged to apply a torque to the steering shaft to supplement a driver input force and change the direction of the steerable wheels. The second power assist assembly includes an electric motor drivingly connected to one of the steering shaft and the linkage assembly. The electric motor is arranged to apply torque to the steering shaft or the linkage assembly to change the direction of the steerable wheels with or without a presence of the driver input force to the steering shaft.

In some configurations of the power steering system of the above paragraph, the first power assist assembly is a hydraulic power assist assembly.

In some configurations of the power steering system of any one or more of the above paragraphs, the hydraulic power assist assembly has a worm and sector gear set or a recirculating ball assembly.

In some configurations of the power steering system of any one or more of the above paragraphs, the second power assist assembly is drivingly connected to the steering shaft.

In some configurations of the power steering system of any one or more of the above paragraphs, the second power assist assembly is drivingly connected to the linkage assembly.

In some configurations of the power steering system of any one or more of the above paragraphs, the power steering system further includes a speed sensor, a rotation angle sensor, and a torque sensor. The speed sensor is operable to output a signal indicative of a speed of a vehicle. The rotation angle sensor is operable to output a signal indicative of a rotational angle of the steering shaft. The torque sensor is operable to output a signal indicative of a steering torque provided to the steering shaft by the driver. The second power assist assembly includes a controller. The controller being in communication with the speed sensor, the rotation sensor, the torque sensor and the electric motor. The controller being operable to control the electric motor based on the signals received from the speed sensor, the rotation angle sensor, and the torque sensor.

In some configurations of the power steering system of any one or more of the above paragraphs, the first power assist assembly and the second power assist assembly operate independently of each other.

In another form, the present disclosure provides a power steering system for a vehicle that includes a front suspension system having a solid axle and steerable wheels. The power steering system includes a rotatable shaft, a linkage assembly, a steering gearbox, and an electric power assist assembly. The linkage assembly is drivingly connected to the steerable wheels. The steering gearbox is drivingly interconnecting the steering shaft and the linkage assembly. The steering gearbox is adapted to transmit a rotational input force from the steering shaft to the linkage assembly to change a direction of the steerable wheels. The electric power assist assembly includes an electric motor drivingly connected to the linkage assembly and being positioned on one of a fore side and an aft side of the solid axle. The electric motor providing output torque to the linkage assembly to change the direction of the steerable wheels without the input force being applied to the steering shaft.

In some configurations of the power steering system of the above paragraph, the steering gearbox has a worm and sector gear set.

In some configurations of the power steering system of any one or more of the above paragraphs, the power steering system further includes a speed sensor, a rotation angle sensor, and a torque sensor. The speed sensor is operable to output a signal indicative of a speed of a vehicle. The rotation angle sensor is operable to output a signal indicative of a rotational angle of the steering shaft. The torque sensor is operable to output a signal indicative of a steering torque provided to the steering shaft by the driver. The electric power assist assembly includes a controller. The controller being in communication with the speed sensor, the rotation sensor, the torque sensor and the electric motor. The controller being operable to control the electric motor based on the signals received from the speed sensor, the rotation angle sensor, and the torque sensor.

In some configurations of the power steering system of any one or more of the above paragraphs, the linkage assembly includes a first link and a second link. The first link being connected to a first wheel of the steerable wheels and configured to steer the first wheel. The second link being connected to a second wheel of the steerable wheels and configured to steer the second wheel.

In yet another form, the present disclosure provides a power steering system for a vehicle that includes a front suspension system having a solid axle and steerable wheels. The power steering system includes a steering shaft, first and second steering knuckles, a steering gearbox, a pitman arm, a first link, a second link, and an electric power assist assembly. The first and second steering knuckles are coupled to the wheels and adapted to steer the wheels. The steering gearbox includes a gear set having an input shaft and an output shaft. The input shaft is drivingly connected to the steering shaft and the output shaft. The pitman arm is drivingly connected to the output shaft of the gear set. The input shaft is adapted to transmit a rotational input force from the steering shaft to drive the pitman arm. The first link has a first end and a second end opposite the first end. The first end is rotatably coupled to the pitman arm and the second end is rotatably coupled to the first steering knuckle. The second link has a first end and a second end opposite the first end. The first end of the second link is rotatably coupled to the first steering knuckle and the second end of the first link is rotatably coupled to the second steering knuckle. The electric power assist assembly includes an electric motor drivingly connected to the first link. The electric motor provides output torque to the first link to change the direction of the steerable wheels without the input force being applied to the steering shaft.

In some configurations of the power steering system of the above paragraph, the electric motor being positioned on one of a fore side and an aft side of the solid axle.

In some configurations of the power steering system of any one or more of the above paragraphs, the power steering system further includes a speed sensor, a rotation angle sensor, and a torque sensor. The speed sensor is operable to output a signal indicative of a speed of a vehicle. The rotation angle sensor is operable to output a signal indicative of a rotational angle of the steering shaft. The torque sensor is operable to output a signal indicative of a steering torque provided to the steering shaft by the driver. The electric power assist assembly includes a controller. The controller being in communication with the speed sensor, the rotation sensor, the torque sensor and the electric motor. The controller being operable to control the electric motor based on the signals received from the speed sensor, the rotation angle sensor, and the torque sensor.

In some configurations of the power steering system of any one or more of the above paragraphs, the electric power assist assembly has a ball and screw linear actuator.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a vehicle including a solid axle suspension system and power steering system in accordance with the present disclosure;

FIG. 2 is a schematic representation of the powering steering system of FIG. 1;

FIG. 3 is a perspective view of the suspension system and the power steering system of FIG. 1;

FIG. 4 is a bottom view of the suspension system and the power steering system of FIG. 1;

FIG. 5 is a perspective view of the power steering system;

FIG. 6 is a top view of the power steering system;

FIG. 7 is a schematic representation of a hydraulic power assist assembly of the power steering system;

FIG. 8 is a perspective view of an alternate power steering system incorporated into the vehicle;

FIG. 9 is a schematic representation of the powering steering system of FIG. 8;

FIG. 10 is a perspective view of the suspension system and the power steering system with a vehicle frame removed for clarity;

FIG. 11 is a bottom view of the suspension system and the power steering system; and

FIG. 12 is a schematic representation of the electric powering steering system.

Corresponding reference numerals indicate corresponding parts throughout the several views of the drawings.

### DETAILED DESCRIPTION

Example embodiments will now be described more fully with reference to the accompanying drawings.

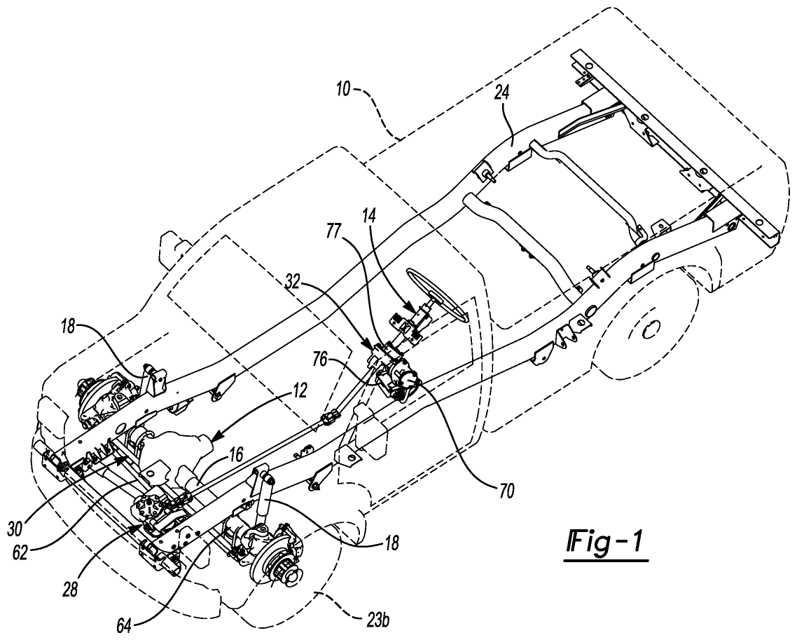

As shown in FIG. 1, a vehicle 10 such as an off-road vehicle or pick-up truck is provided. The vehicle 10 may include a front suspension system 12, a rear suspension system (not shown) and a power steering system 14. The front suspension system 12 may be a solid axel suspension system and may include, inter alia, a solid or straight axel 16, shock absorbers 18, coil springs (not shown), and leaf springs (not shown). The solid axle attaches a front set of wheels 23a, 23b such that when one of the wheels 23a, 23b articulates (moves up or down) the other wheel 23a, 23b moves in the same or opposite direction. The shock absorbers 18 dampen movement of the wheels 23a, 23b with respect to a vehicle frame 24. The coil springs and the leaf springs support the load of the vehicle 10 and absorb road impact transmitted through the wheels 23a, 23b. The structure and function of the rear suspension system may be the same or similar to the front suspension system 12, and therefore, will not be described again in detail.

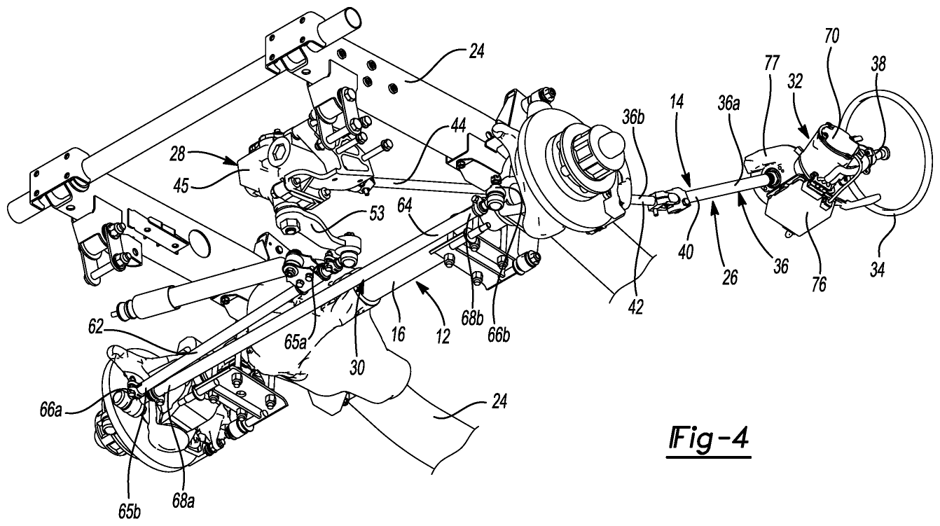

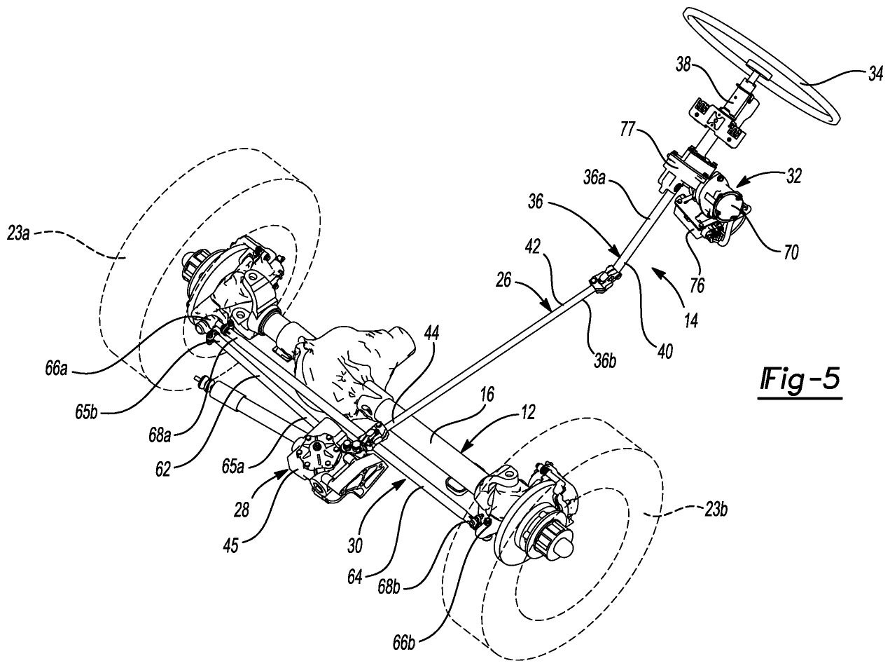

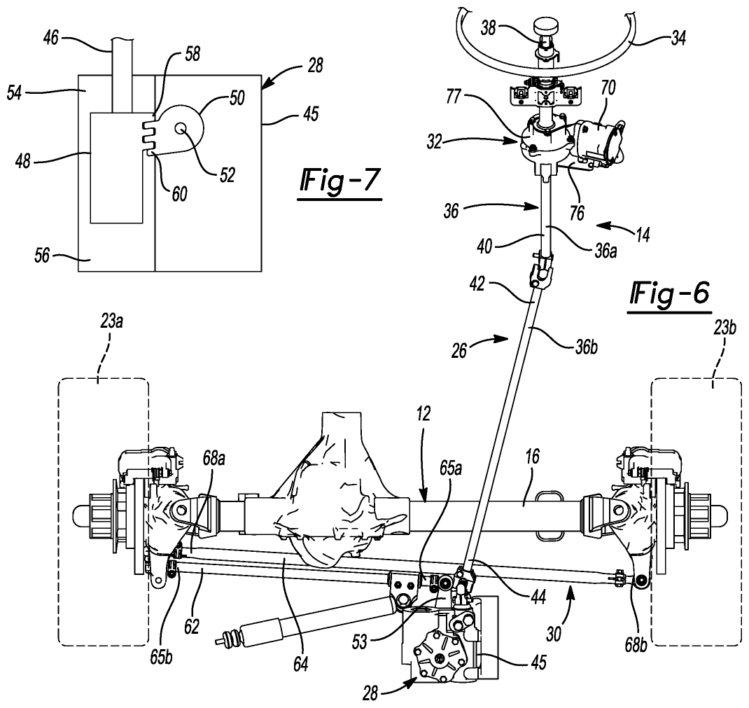

With reference to FIG. 1-7, the power steering system 14 may include a steering assembly 26 (FIGS. 1-6), a first power assist assembly 28, a linkage assembly 30 (FIGS. 1-6), and a second power assist assembly 32 (FIGS. 1-6). The steering assembly 26 includes a steering wheel 34 operated by a driver, and a rotatable steering column or shaft 36 that rotates together with the steering wheel 34. The steering shaft 36 includes a first shaft member 36a and a second shaft member 36b. The first shaft member 36a may include a first end 38 and a second end 40 opposite the first end 38. The first end 38 of the first shaft member 36a is coupled to the steering wheel 34 such that rotation of the steering wheel 34 causes the first shaft member 36a to rotate. The second end 40 of the first shaft member 36a is coupled to the second shaft member 36b via a joint coupling. The second shaft member 36b may include a first end 42 and a second end 44 opposite the first end 42. The second end 44 is drivingly connected to the first power assist assembly 28.

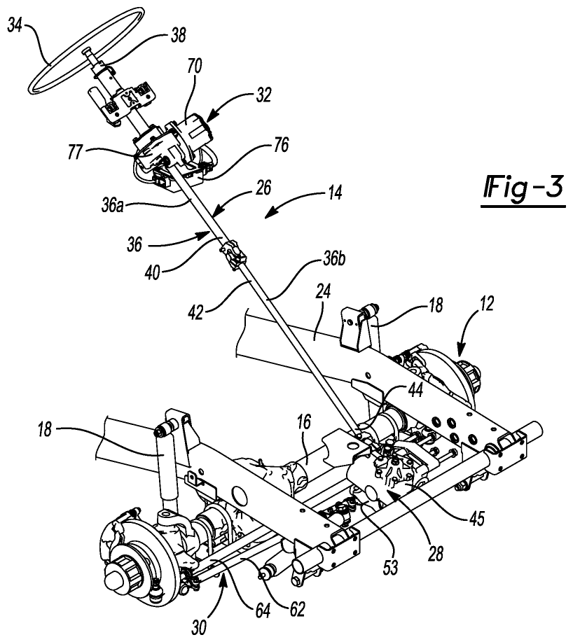

The first power assist assembly 28 may be a hydraulic power assist assembly and may be arranged to apply a torque to the steering shaft 36 to supplement the driver input force and change the direction of the wheels 23a, 23b. With reference to FIGS. 3, 4, 6 and 7, the first power assist assembly 28 includes a steering box 45, an input shaft 46 (FIG. 7), a piston 48 (FIG. 7), a sector gear 50 (FIG. 7), an output shaft 52 (FIG. 7), and a pitman arm 53 (FIGS. 3, 4, and 6). The input shaft 46, the piston 48, the sector gear 50 and the output shaft 52 are disposed within the steering box 45. The input shaft 46 is drivingly connected to the second end 44 of the second shaft member 36b and the piston 48. The piston 48 separates working chambers 54, 56 of the steering box 45 and includes teeth 58 that are engaged with teeth 60 of the sector gear 50. The sector gear 50 is drivingly connected to the output shaft 52. The output shaft 52 is drivingly connected to the pitman arm 53, which, in turn, is drivingly connected to the linkage assembly 30.

Rotation of the steering shaft 36 causes the input shaft 46 to rotate, which moves the piston 48 up and down. Movement of the piston 48 causes the sector gear 50 to turn which rotates the output shaft 52. Rotation of the output shaft 52 rotates the pitman arm 53 (the pitman arm 53 rotates about an axis of the output shaft 52), which steers the wheels 23a, 23b via the linkage assembly 30. Hydraulic fluid in a reservoir (not shown) may be supplied to one of the working chambers 54, 56 via a pump (not shown), thereby applying a torque to the steering shaft 36 to supplement the driver input force. For example, when the driver begins to turn the steering shaft 36 (via steering wheel 34) in a first rotational direction, hydraulic fluid may be pumped to the working chamber 56 which facilitates the piston 48 upwardly and the steering shaft 36 being rotated in the first rotational direction. Similarly, when the driver begins to turn the steering shaft 36 (via steering wheel 34) in a second rotational direction which is opposite the first rotational direction, hydraulic fluid may be pumped to the working chamber 54 which facilitates the piston 48 downwardly and the steering shaft 36 being rotated in the section rotational direction.

As shown in FIGS. 1-6, the linkage assembly 30 includes a first link or input member 62 and a second link or tie rod 64. The input member 62 includes a first end 65a and a second end 65b opposite the first end 65a. The first end 65a is drivingly connected to the pitman arm 53 and the second end 65b is drivingly connected to the wheel 23a (via a wheel knuckle 66a). The tire rod 64 includes a first end 68a and a second end 68b opposite the first end 68a. The first end 68a is drivingly connected to the wheel 23a (via the wheel knuckle 66a) and the second end 68b is drivingly connected to the wheel 23b (via wheel knuckle 66b). In this way, when the pitman arm 53 rotates, as described above, the input member 62 may change a direction of the steerable wheel 23a and the tie rod 64 may change a direction of the steerable wheel 23b.

The second power assist assembly 32 is an electric power assist assembly and is drivingly connected to the steering shaft 36 (the first shaft member 36a of the shaft 36). The second power assist assembly 32 may be arranged to apply a torque to the steering shaft 36 to supplement the driver input force and change the direction of the wheels 23a, 23b. The second power assist assembly 32 is operable independently of the first power assist assembly 28.

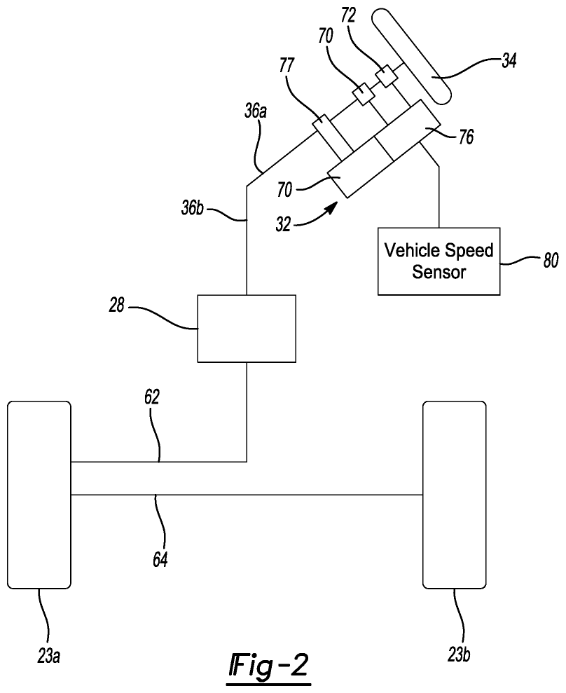

With reference to FIGS. 1-6, the second power assist assembly 32 includes an electric motor 70, a rotation angle sensor 72 (FIG. 2), a torque sensor 74 (FIG. 2), and a controller 76. The electric motor 70 may be a three-phase alternating current motor such as a brushless motor and may be drivingly connected to the steering shaft 36 via a reduction gear set 77 which reduces the speed of rotation of the electric motor 70, and transmits the rotation with a reduced speed to the steering shaft 36. The electric motor 70 may be arranged to apply torque to the steering shaft 36 to change the direction of the steerable wheels 23a, 23b with or without the presence of the driver input force to the steering shaft 36.

The rotation angle sensor 72 is associated with the steering shaft 36 and is in communication with the controller 76. The rotation angle sensor 72 is configured to detect a rotational angle of the steering shaft 36 and is operable to output a signal indicative of the steering shaft angle to the controller 76. The torque sensor 74 is coupled to the steering shaft 36 and is in communication with the controller 76. The torque sensor 74 is configured to detect a steering torque applied to the steering shaft 36 through the steering wheel 34 and is operable to output a signal indicative of the steering torque to the controller 76.

As shown in FIG. 2, a vehicle speed sensor 80 is in communication with the controller 76 and is configured to detect a speed of the vehicle 10. The vehicle speed sensor 80 is operable to output a signal indicative of the vehicle speed and the signal may be communicated to the controller 76. The controller 76 is configured to operate the electric motor 70 based in part on data received from the vehicle speed sensor 80, the rotation angle sensor 72, and the torque sensor 74.

One of the advantages of the power steering system 14 of the present disclosure is that the electric power assist assembly 32 can be retro-fitted on vehicles having a solid axle suspension system and a hydraulic power assist assembly. In this way, the vehicle may be made autonomous such that it can drive itself without the need of a driver input force to the steering assembly.

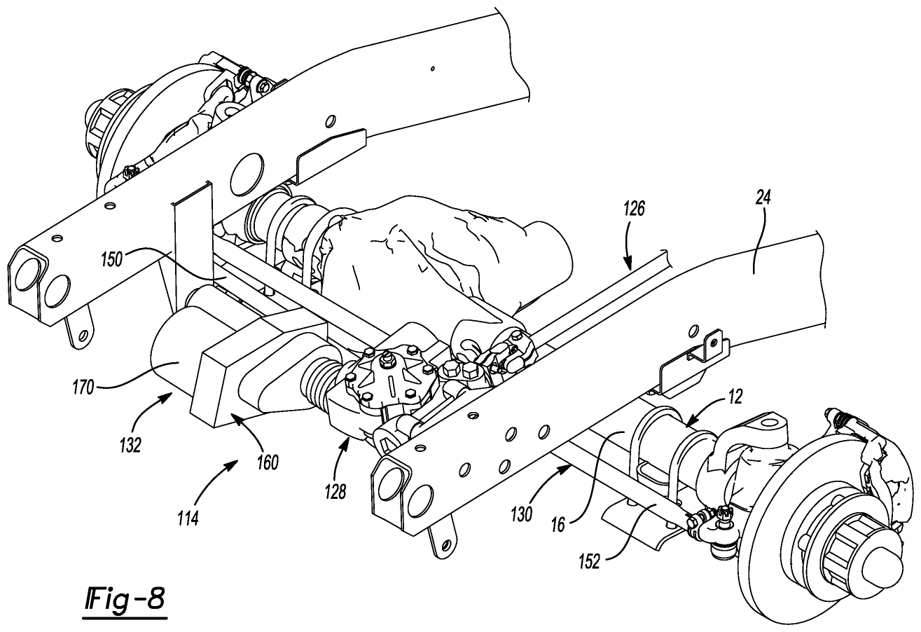

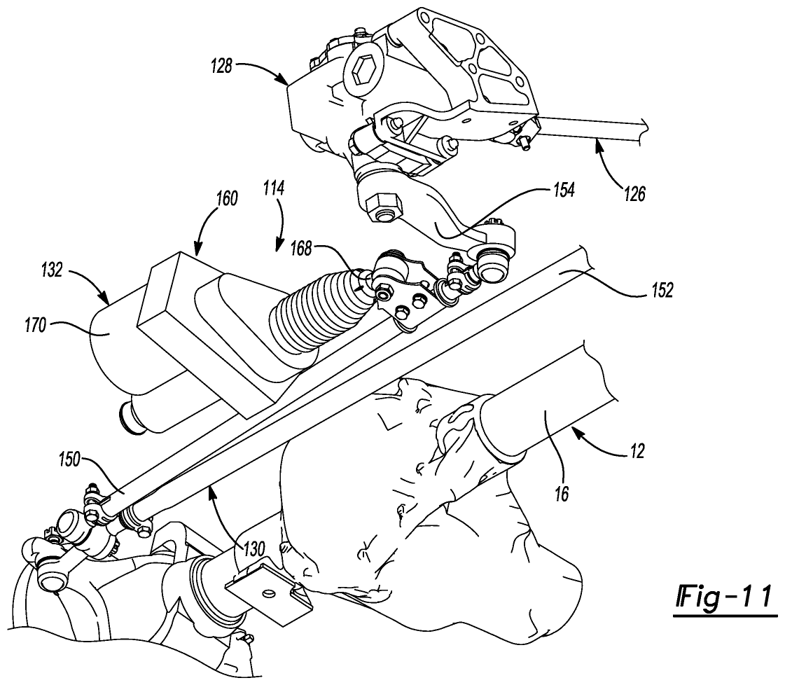

With continued reference to FIGS. 8-12, another power steering system 114 is provided. The power steering system 114 may be incorporated into the vehicle 10 instead of power steering system 14. The structure and function of the power steering system 114 may be similar or identical to that of power steering system 14, apart from the exceptions described below.

With reference to FIGS. 8-12, the power steering system 114 may include a steering assembly 126 (FIGS. 8-11), a first power assist assembly 128 (FIGS. 8-11), a linkage assembly 130 (FIGS. 8-11), and a second power assist assembly 132. The structure and function of the steering assembly 126 may be similar or identical to that of the steering assembly 26 described above, and therefore, will not be described again in detail. The structure and function of the first power assist assembly 128 may be similar or identical to that of the first power assist assembly 28 described above, and therefore, will not be described again in detail. The first power assist assembly 128 may be a hydraulic power assist assembly. In some configurations, the hydraulic features may be removed from the assembly 128 such that the assembly 128 functions only as a steering box.

The linkage assembly 130 includes a first link or input member 150 and a second link or tie rod 152. A first end of the first link 150 is drivingly connected to a pitman arm 154 of the first power assist assembly 128 and a second end of the first link 150 is drivingly connected to the wheel 23a. A first end of the second link 152 is drivingly connected to the wheel 23a and the second end of the second link 152 is drivingly connected to the wheel 23b.

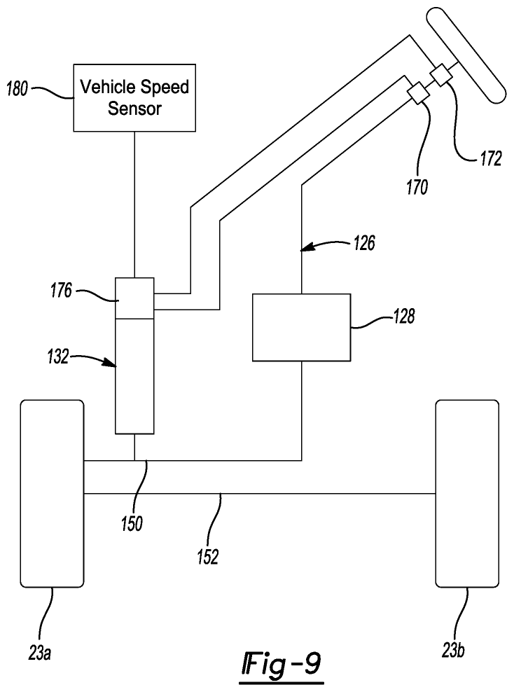

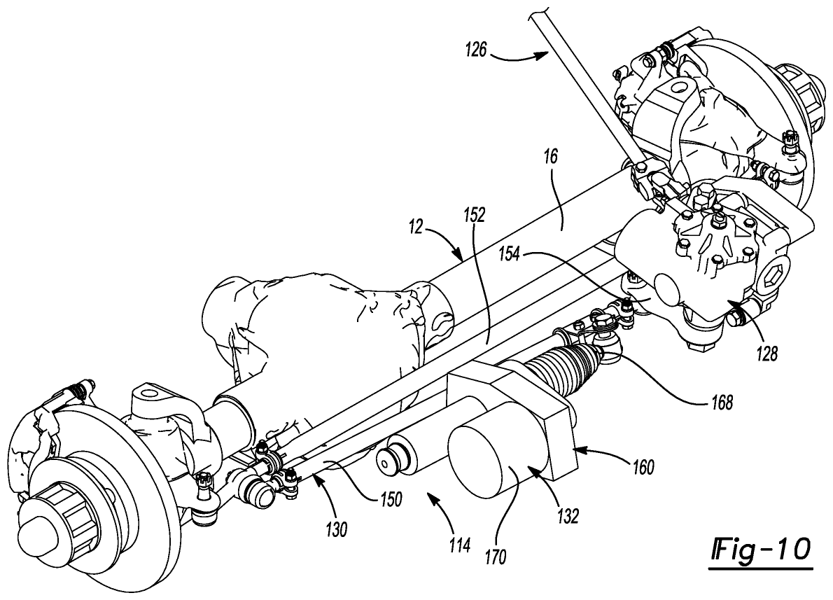

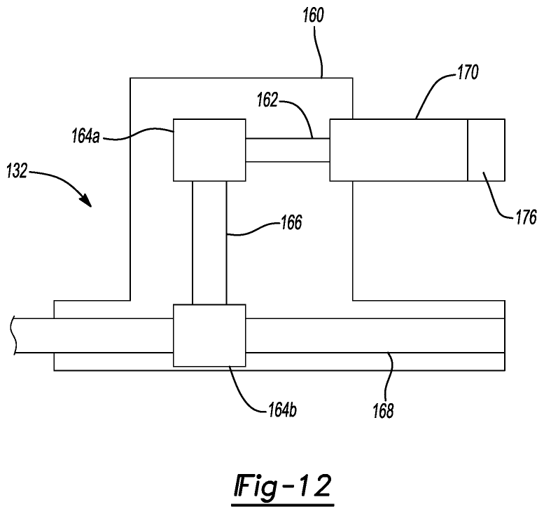

The second power assist assembly 132 may be supported by the frame 24 of the vehicle 10 and may be a ball and screw linear actuator. The second power assist assembly 132 may include a housing 160, a shaft 162 (FIG. 12), first and second gears 164a, 164b (FIG. 12), a belt 166 (FIG. 12), a ball screw rack 168 (FIGS. 10-12), an electric motor 170, a rotation angle sensor 172 (FIG. 9), a torque sensor 174 (FIG. 9) and a controller 176 (FIGS. 9 and 12). The shaft 162, the first and second gears 164a, 164b, the belt 166 and the ball screw rack 168 are housed in the housing 160. The shaft 162 is drivingly connected to the motor 170 and the first gear 164a so the motor 170 applies a torque to the first gear 164a via the shaft 162. The belt 166 is drivingly connected to the first and second gears 164a, 164b so that rotation of the first gear 164a causes rotation of the second gear 164b. The second gear 164b is drivingly connected to the ball screw rack 168, thereby causing the rack 168 to move laterally (side-to-side) when the second gear 164b rotates. The rack 168 is drivingly conned to the first link 150 of the linage assembly 130. In this way, when the rack 168 moves laterally, the first link 150 may change a direction of the steerable wheel 23a and the second link 152 may change a direction of the steerable wheel 23b.

The rotation angle sensor 172 is associated with a steering shaft 136 of the steering assembly 126 and is in communication with the controller 176. The rotation angle sensor 172 is configured to detect a rotational angle of the steering shaft 136 and communicate this data to the controller 176. The torque sensor 174 is coupled to the steering shaft 136 and is in communication with the controller 176. The torque sensor 174 is configured to detect a steering torque applied to the steering shaft 136 and communicate this data to the controller 176.

As shown in FIG. 9, a vehicle speed sensor 180 is in communication with the controller 176 and is configured to detect a speed of the vehicle 10. The vehicle speed sensor 180 may communicate this data to the controller 176. The controller 176 is configured to operate the electric motor 170 based in part on data received from the vehicle speed sensor 180, the rotation angle sensor 172, and the torque sensor 174.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In this application, including the definitions below, the term ‘module’ may be replaced with the term ‘circuit.’ The term ‘module’ may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “for.”

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power steering system for a vehicle including steerable wheels, the power steering system comprising:
a rotatable steering shaft;
a linkage assembly including an input member drivingly connected to the steering shaft and an output member adapted to be drivingly connected to the steerable wheels, wherein a driver input force to the steering shaft by a driver is transferred through the linkage to change a direction of the steerable wheels;
a first power assist assembly drivingly connected to the steering shaft and arranged to apply a torque to the steering shaft to supplement the driver input force and change the direction of the steerable wheels; and
a second power assist assembly including an electric motor drivingly connected to one of the steering shaft and the linkage assembly, the electric motor arranged to apply torque to the one of the steering shaft and the linkage assembly to change the direction of the steerable wheels with or without a presence of the driver input force to the steering shaft.

2. The power steering system of claim 1, wherein the first power assist assembly is a hydraulic power assist assembly.

3. The power steering system of claim 2, wherein the hydraulic power assist assembly has a worm and sector gear set or a recirculating ball assembly.

4. The power steering system of claim 1, wherein the second power assist assembly is drivingly connected to the steering shaft.

5. The power steering system of claim 1, wherein the second power assist assembly is drivingly connected to the linkage assembly.

6. The power steering system of claim 5, further comprising:
a speed sensor operable to output a signal indicative of a speed of a vehicle;
a rotation angle sensor operable to output a signal indicative of a rotational angle of the steering shaft, and
a torque sensor operable to output a signal indicative of a steering torque provided to the steering shaft by the driver, wherein
the second power assist assembly includes a controller, the controller being in communication with the speed sensor, the rotation sensor, the torque sensor and the electric motor, the controller being operable to control the electric motor based on the signals received from the speed sensor, the rotation angle sensor, and the torque sensor.

7. The power steering system of claim 1, wherein the first power assist assembly and the second power assist assembly operate independently of each other.

8. A power steering system for a vehicle including a front suspension system having a solid axle and steerable wheels, the power steering system comprising:
a steering shaft;
a linkage assembly drivingly connected to the steerable wheels;
a steering gearbox drivingly interconnecting the steering shaft and the linkage assembly, the steering gearbox adapted to transmit a rotational input force from the steering shaft to the linkage assembly to change a direction of the steerable wheels; and
an electric power assist assembly including an electric motor drivingly connected to the linkage assembly and being positioned on one of a fore side and an aft side of the solid axle, the electric motor providing output torque to the linkage assembly to change the direction of the steerable wheels without the input force being applied to the steering shaft.

9. The power steering system of claim 8, wherein the steering gearbox has a worm and sector gear set.

10. The power steering system of claim 8, further comprising:
a speed sensor operable to output a signal indicative of a speed of a vehicle;
a rotation angle sensor operable to output a signal indicative of a rotational angle of the steering shaft; and
a torque sensor operable to output a signal indicative of a steering torque provided to the steering shaft by a driver, wherein
the electric power assist assembly includes a controller, the controller being in communication with the speed sensor, the rotation sensor, the torque sensor and the electric motor, the controller being operable to control the electric motor based on the signals received from the speed sensor, the rotation angle sensor, and the torque sensor.

11. The power steering system of claim 8, wherein the linkage assembly includes a first link and a second link, the first link being connected to a first wheel of the steerable wheels and configured to steer the first wheel, the second link being connected to a second wheel of the steerable wheels and configured to steer the second wheel.

12. A power steering system for a vehicle including a front suspension system having a solid axle and steerable wheels, the power steering system comprising:
a steering shaft;
first and second steering knuckles coupled to the wheels and adapted to steer the wheels;
a steering gearbox including a gear set having an input shaft and an output shaft, the input shaft drivingly connected to the steering shaft and the output shaft;
a pitman arm drivingly connected to the output shaft of the gear set, the input shaft adapted to transmit a rotational input force from the steering shaft to drive the pitman arm;
a first link having a first end and a second end opposite the first end, the first end rotatably coupled to the pitman arm and the second end rotatably coupled to the first steering knuckle;
a second link having a first end and a second end opposite the first end, the first end of the second link rotatably coupled to the first steering knuckle and the second end of the first link rotatably coupled to the second steering knuckle; and
an electric power assist assembly including an electric motor drivingly connected to the first link, the electric motor providing output torque to the first link to change the direction of the steerable wheels without the input force being applied to the steering shaft.

13. The power steering system of claim 12, wherein the electric motor being positioned on one of a fore side and an aft side of the solid axle.

14. The power steering system of claim 12, further comprising:
a speed sensor operable to output a signal indicative of a speed of a vehicle;
a rotation angle sensor operable to output a signal indicative of a rotational angle of the steering shaft, and
a torque sensor operable to output a signal indicative of a steering torque provided to the steering shaft by a driver, wherein
the electric power assist assembly includes a controller, the controller being in communication with the speed sensor, the rotation sensor, the torque sensor and the electric motor, the controller being operable to control the electric motor based on the signals received from the speed sensor, the rotation angle sensor, and the torque sensor.

15. The power steering system of claim 12, wherein the electric power assist assembly has a ball and screw linear actuator.
